(19) United States
(12) Patent Application Publication
(10) Pub. No.: US 2016/0060582 A1
(43) Pub. Date: Mar. 3, 2016

(54) METHOD OF LAUNDERING FABRIC

(71) Applicant: The Procter & Gamble Company, Cincinnati, OH (US)

(72) Inventors: Ryohei OHTANI, Nishinomiya (JP); Fei LI, Beijing (CN); Qiupeng YAO, Beijing (CN); Yu ZHAO, Beijing (CN)

(21) Appl. No.: 14/938,967

(22) Filed: Nov. 12, 2015

Related U.S. Application Data
(63) Continuation of application No. PCT/CN2015/078521, filed on May 8, 2015.

(30) Foreign Application Priority Data
May 12, 2014 (WO) CN2014/077219
May 12, 2014 (WO) CN2014/077226
May 12, 2014 (WO) CN2014/077257

(51) Int. Cl. C11D 3/48; C11D 1/22; C11D 1/28

(52) U.S. Cl. CPC C11D 3/48; C11D 1/28; C11D 1/22

(57) ABSTRACT

The present invention relates to a method of laundering fabric using a laundry washing liquor containing a relatively low Through-The-Wash (TTW) dosage of a diphenyl ether anti-microbial agent. Such relatively low TTW ranges from about 0.25 to about 1 ppm, but it surprisingly and unexpectedly exhibits antimicrobial effect that is comparable with higher TTW dosage. The present invention also relates to anti-microbial laundry detergent compositions designed for delivering, or laundry washing liquors that contain, such a low TTW dosage of the diphenyl ether anti-microbial agent.

### FIELD OF THE INVENTION

The present invention relates to a method of laundering fabric using an anti-microbial laundry detergent composition.

### BACKGROUND OF THE INVENTION

Consumer products have evolved to address user needs for an anti-microbial benefit, in addition to their original intended functions. For example, an anti-microbial laundry detergent product is desired by users as it cleans fabrics whilst having an anti-microbial benefit on fabrics. Currently, various anti-microbial agents, e.g., diphenyl ethers, are known for use in consumer product formulations to deliver an anti-microbial effect.

However, in a context of laundry detergent it is challenging to achieve a desired efficacy of the anti-microbial agents on fabrics. Specifically, during a washing cycle, most of the active ingredients, including the incorporated anti-microbial agents, are eventually washed away along with the washing solution. Such, only a small amount of anti-microbial agents released by the laundry detergent can be deposited onto washed fabrics, and therefore the actual anti-microbial effect of these laundry detergents is quite limited. More importantly, the anti-microbial agents washed away during the laundering process not only attribute to unnecessary increase in the overall manufacturing cost of the laundry detergent, but may also raise environmental concerns.

Therefore, there is a need for reducing the amount of anti-microbial agents washed away during the laundering process and minimizing the release thereof into the environment, but without significantly compromising the overall anti-microbial effect achieved by the laundering process.

### SUMMARY OF THE INVENTION

It has been discovered by inventors of the present invention, surprisingly and unexpectedly, that certain diphenyl ether anti-microbial agents can achieve sufficient anti-microbial effect against both gram-positive bacteria and gram-negative bacteria at significantly lower Through-The-Wash (TTW) dosage than conventionally used. Correspondingly, a lesser amount of such diphenyl ether anti-microbial agents is released into the environment through wash, thereby reducing or minimizing the environmental footprint of the laundry detergent composition containing such diphenyl ether anti-microbial agents.

In one aspect, the present invention is related to a method of laundering fabric, including the steps of:
a) forming an anti-microbial laundry detergent composition that comprises a diphenyl ether anti-microbial agent;
b) diluting such anti-microbial laundry detergent composition with water or an aqueous solution by an order ranging from 900 to 3000 times by weight to form a laundry washing liquor having a Through-The-Wash (TTW) dosage of the diphenyl ether anti-microbial agent ranging from 0.25 to 1 ppm; and
c) contacting fabrics in need of laundering with the laundry washing liquor.

In another aspect, the present invention is related to a laundry washing liquor containing an aqueous solution of a diphenyl ether anti-microbial agent with a Through-The-Wash (TTW) dosage ranging from 0.25 to 1 ppm.

In yet another aspect, the present invention is related to an anti-microbial laundry detergent composition, containing a diphenyl ether anti-microbial agent in an amount sufficient for delivering a Through-The-Wash (TTW) dosage of the diphenyl ether anti-microbial agent ranging from 0.25 to 1 ppm in a laundry washing liquor formed by such anti-microbial laundry detergent composition.

### BRIEF DESCRIPTION OF THE DRAWINGS

FIG. 1 is a graph showing the anti-microbial effects of 4-4′-dicholo-2-hydroxy diphenyl ether against gram-positive and gram-negative bacteria at different TTW dosages.

### DETAILED DESCRIPTION OF THE INVENTION

### Definitions

As used herein, the term “laundry detergent composition” means a composition relating to cleaning fabrics. The laundry detergent composition can be either powder or liquid, but preferably is liquid. The term “liquid laundry detergent composition” herein refers to compositions that are in a form selected from the group consisting of pourable liquid, gel, cream, and combinations thereof. The liquid laundry detergent composition may be either aqueous or non-aqueous, and may be anisotropic, isotropic, or combinations thereof.

As used herein, the term “anti-microbial agent” refers to a chemical compound of which the principle intended function is to kill bacteria or to prevent their growth or reproduction. Traditional anti-microbial agents include cationic anti-microbial agents (e.g., certain ammonium chlorides), nonionic anti-microbial agents, etc. Diphenyl ether compounds that are used in the present invention are nonionic anti-microbial agents.

The terms “laundry washing liquor,” “laundering liquor,” “laundering solution” and “washing solution” are used interchangeably herein to refer to the aqueous detersive solution used for one cycle of laundry washing. The laundry washing liquor is formed by dissolving a recommended amount or dosage of a laundry detergent composition in a recommended volume of water or aqueous solution. Volume of the laundry washing liquor is preferably from 1 liter to 70 liters, alternatively from 1 liter to 20 liters for hand washing and from 8 liters to 70 liters for machine washing.

As used herein, the term “Through-The-Wash dosage” or “TTW dosage” regarding the diphenyl ether anti-microbial agent is defined as the parts-per-million (ppm) concentration of the diphenyl ether anti-microbial agent in the laundry washing liquor formed by dissolving a recommended dosage of a laundry detergent composition in a recommended volume of water or aqueous solution. For example, if a laundry detergent composition contains 0.04 wt % of the diphenyl ether anti-microbial agent, and the recommended dosage of this laundry detergent composition is 50 grams per 45 liters of water, the TTW dosage of the diphenyl ether anti-microbial agent is (0.04 wt %×50 grams)/(45 liters×1000 grams/liter+50 grams)×1000000 ppm/wt %=0.444 ppm.

As used herein, the term “alkyl” means a hydrocarbyl moiety which is branched or unbranched, substituted or unsubstituted. Included in the term “alkyl” is the alkyl portion of acyl groups.

As used herein, when a composition is “substantially free” of a specific ingredient, it is meant that the composition comprises less than a trace amount, alternatively less than 0.1%, alternatively less than 0.01%, alternatively less than 0.001%, by weight of the composition, of the specific ingredient.

As used herein, the articles including “a” and “an” when used in a claim, are understood to mean one or more of what is claimed or described.

As used herein, the terms “comprise”, “comprises”, “comprising”, “include”, “includes”, “including”, “contain”, “contains”, and “containing” are meant to be non-limiting, i.e., other steps and other ingredients which do not affect the end of result can be added. The above terms encompass the terms “consisting of” and “consisting essentially of”.

### Anti-Microbial Agent

The anti-microbial agents used for the present invention, diphenyl ethers, are nonionic. In the present invention, it has been found that due to their nonionic property, the diphenyl ether anti-microbial agents of the present invention allow for formation of a stable liquid anti-microbial laundry detergent composition. By contrast, traditional cationic anti-microbial agents are typically not compatible with anionic surfactants present in the laundry detergent compositions. Diphenyl ethers suitable for use herein are described from Col. 1, line 54 to Col. 5, line 12 in U.S. Pat. No. 7,041,631B.

The anti-microbial agent is preferably a hydroxyl diphenyl ether. The anti-microbial agent herein can be either halogenated or non-halogenated, but preferably is halogenated. In one embodiment, the anti-microbial agent is a hydroxyl diphenyl ether of formula (I):

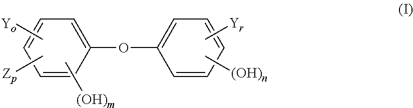

wherein:
each Y is independently selected from chlorine, bromine, or fluorine, preferably is chlorine or bromine, more preferably is chlorine,
each Z is independently selected from SO₂H, NO₂, or C₁-C₄ alkyl,
r is 0, 1, 2, or 3, preferably is 1 or 2,
o is 0, 1, 2, or 3, preferably is 0, 1 or 2,
p is 0, 1, or 2, preferably is 0,
m is 1 or 2, preferably is 1, and
n is 0 or 1, preferably is 0.

In the above definition for formula (I), 0 means nil. For example, when p is 0, then there is no Z in formula (I). Each Y and each Z could be the same or different. In one embodiment, o is 1, r is 2, and Y is chlorine or bromine. This embodiment could be: one chlorine atom bonds to a benzene ring while the bromine atom and the other chlorine atom bond to the other benzene ring; or the bromine atom bonds to a benzene ring while the two chlorine atoms bond to the other benzene ring.

More Preferably, the anti-microbial agent is selected from the group consisting of 4-4′-dichloro-2-hydroxy diphenyl ether (“Diclosan”), 2,4,4′-trichloro-2′-hydroxy diphenyl ether (“Triclosan”), and a combination thereof. Most preferably, the anti-microbial agent is 4-4′-dichloro-2-hydroxy diphenyl ether, commercially available from BASF, under the trademark name Tinosan®HP100.

In addition to the diphenyl ether, other anti-microbial agents may also be present, provided that these are not present at a level which causes instability in the formulation. Among such useful further antimicrobial agents are chelating agents, which are particularly useful in reducing the resistance of Gram negative microbes in hard water. Acid biocides may also be present.

### Low Through-the-Wash (TTW) Dosage of the Diphenyl Ether Anti-Microbial Agent

As mentioned hereinabove, diphenyl ether anti-microbial agents have been described in U.S. Pat. No. 7,041,631B. However, they have been conventionally used in a relatively high Through-The-Wash (TTW) dosage, e.g., from about 3 ppm to about 20 ppm.

For example, U.S. Pat. No. 7,041,631B discloses in Example 3 a detergent formulation 8 that contains 0.6 wt % of a 30% active solution containing a diphenyl ether compound, which is equivalent to a diphenyl ether concentration of about 0.18 wt %. Such formulation 8 is used for washing fabrics under standard washing conditions with a recommended dosage of 2.3 grams of detergent in a 300 ml washing liquor, so the TTW dosage of the diphenyl ether compound is (0.18 wt %×2.3 grams)/(1 g/ml×300 ml+2.3 grams)×1000000 ppm/wt %≈14 ppm. U.S. Pat. No. 7,041,631B also discloses in Example 5 several detergent formulations 20-22 that contain 0.13 wt % of a 30% active solution of the diphenyl ether compound, which is equivalent to a diphenyl ether concentration of about 0.039 wt %. When used under the above-described washing conditions, the TTW dosage of the diphenyl ether compound is (0.039 wt %×2.3 grams)/(1 g/ml×300 ml+2.3 grams)×1000000 ppm/wt %˜3 ppm.

Such high TTW dosages were believed by conventional wisdom as necessary for depositing a sufficient amount of the diphenyl ether anti-microbial agent onto the fabrics treated in order to effectuate the desired anti-microbial effect.

Surprisingly and unexpectedly, it has been discovered by inventors of the present invention that when used at a significantly lower TTW dosage, e.g., 1 ppm or lower, the diphenyl ether anti-microbial agents can still achieve sufficient anti-microbial effect against both gram-positive bacteria and gram-negative bacteria. Specifically, the anti-microbial effect of the diphenyl ether anti-microbial agents “plateaus” within a critical TTW dosage ranging from about 0.25 ppm to about 1 ppm. Therefore, when the TTW dosage of the diphenyl ether anti-microbial agent used falls within this critical TTW dosage range, which is significantly lower than the above-described conventional TTW dosages, it can achieve essentially the same or comparable anti-microbial effect as at the conventional high TTW dosages.

Use of the diphenyl ether anti-microbial agent at this lower, critical TTW dosage range can significantly reduce the amount of such diphenyl ether anti-microbial agent released into the environment through wash, thereby reducing or minimizing the environmental footprint of the laundry detergent composition containing such diphenyl ether anti-microbial agents. Further, the manufacturing costs associated with such diphenyl ether anti-microbial agent can also be substantially reduced. Thus, it is more advantageous to use the diphenyl ether anti-microbial agents within the lower, critical TTW dosage range.

Preferably, the diphenyl ether anti-microbial agent is used at a TTW dosage ranging from about 0.3 ppm to about 0.7 ppm, more preferably from about 0.4 ppm to about 0.6 ppm, and most preferably from about 0.45 ppm to 0.55 ppm.

In a particularly preferred embodiment, the diphenyl ether anti-microbial agent is used at a TTW dosage sufficient to provide a Bacteriostatic Activity Value (as described in the Test Method section hereinafter) of at least log 1.7, preferably at least log 2, and more preferably at least log 2.1, for both Gram positive bacteria and Gram negative bacteria.

On one hand, the diphenyl ether anti-microbial agent is preferably used at a TTW dosage sufficient to provide a Bacteriostatic Activity Value of at least log 3.4, more preferably at least log 3.6 and most preferably at least log 3.8, for the Gram positive bacteria Staphylococcus aureus after a 10 minutes contact time as determined by the JISL 1902 method described hereinbelow.

On the other hand, the diphenyl ether anti-microbial agent is preferably used at a TTW dosage sufficient to provide a Bacteriostatic Activity Value of at least log 1.7, more preferably at least log 2.1 and most preferably at least log 2.2, for the Gram negative bacteria Klebsiella pneumoniae. It is worth noting that Staphylococcus aureus is frequently found on human skin, and therefore fabrics (particularly wearing fabrics) are in particular need of anti-microbial effects against Staphylococcus aureus.

### Anti-Microbial Laundry Detergent Composition

The anti-microbial laundry detergent composition of the present invention comprises the diphenyl ether anti-microbial agent, preferably in an amount ranging from about 0.02% to about 0.3%, more preferably from about 0.03% to about 0.2%, and most preferably from about 0.04 to about 0.1%, by total weight of the anti-microbial laundry detergent composition.

The absolute concentration of the diphenyl ether anti-microbial agent in the detergent composition is not critical for the practice of the present invention, but needs to be considered together with the recommended dosage of the detergent composition for determining the TTW dosage of the diphenyl ether.

The typically recommended dosage of the anti-microbial laundry detergent composition of the present invention may vary from as low as 1 gram of detergent per 50 liters of water (20 ppm TTW dosage for the detergent) to as high as 100 grams of detergent per 5 liters of water (20000 ppm TTW dosage for the detergent), depending on the types of washing conducted, e.g., machine washing or hand washing. Typically recommended detergent dosages for machine washing are, for example, 47.7 grams of detergent per 45 liters of water, 10 grams of detergent per 30 liters of water, 16 grams of detergent per 45 liters of water, 20 grams of detergent per 55 liters of water, 24 grams of detergent per 65 liters of water, and the like. Typically recommended detergent dosages for hand washing are, for example, 5 grams, 10 grams, 25 grams, and 50 grams. Such recommended detergent dosages result in a dilution of the anti-microbial laundry detergent composition by an order ranging from about 900 times to about 3000 times by weight. The dilution is preferably made with water, but it can also be made with any other suitable aqueous solution.

The recommended dosage of the anti-microbial detergent composition is also not critical for the practice of the present invention, but needs to be considered together with the concentration of the diphenyl ether anti-microbial agent in the detergent composition for determining the final TTW dosage of the diphenyl ether.

The anti-microbial detergent composition of the present invention may comprise one or more detersive surfactants, which are preferably, but not necessarily, anionic and/or nonionic. Preferably, the detersive surfactants are selected from the group consisting of: (1) C₁₀-C₂₀ linear alkyl benzene sulphonates; (2) C₁₀-C₂₀ linear or branched alkylalkoxy sulfates having a weight average degree of alkoxylation ranging from about 0.1 to about 5.0; (3) C₁₀-C₂₀ linear or branched alkyl sulfates; (4) C₁₀-C₂₀ linear or branched alkyl ester sulfates; (5) C₁₀-C₂₀ linear or branched alkyl ester sulfonates; (6) C₁₀-C₂₀ linear or branched alkyl ester alkoxylates; (7) C₈-C₂₂ alkyl alkoxylated alcohols having a weight average degree of alkoxylation from about 1 to about 60; and combinations thereof.

### Anionic Surfactant System

In a particularly preferred embodiment of the present invention, the anti-microbial laundry detergent composition comprises at least one anionic surfactant selected from the group consisting of C₁₀-C₂₀ linear alkyl benzene sulphonates (LAS), C₁₀-C₂₀ linear or branched alkylalkoxy sulfates having an average degree of alkoxylation ranging from about 0.1 to about 5.0 (AES), and combinations thereof.

In one embodiment, LAS is C₁₀-C₁₆ LAS. The LAS is normally prepared by sulfonation (using SO₂ or SO₃) of alkylbenzenes followed by neutralization. Suitable alkylbenzene feedstocks can be made from olefins, paraffins or mixtures thereof using any suitable alkylation scheme, including sulfuric and HF-based processes. By varying the precise alkylation catalyst, it is possible to widely vary the position of covalent attachment of benzene to an aliphatic hydrocarbon chain. Accordingly the LAS herein can vary widely in 2-phenyl isomer and/or internal isomer content.

In one embodiment, AES is C₁₀-C₁₈ AES wherein preferably x is from 1 to 3. Mid-chain branched AES with C₁₁-C₁₅ are particularly preferred.

In the laundry detergent composition, the levels of the AES and LAS can be adjusted as long as the total level of the two falls within the range of 3% to 50%, by weight of the composition. In one embodiment, the weight ratio of the AES to LAS is from 0.1:1 to 10:1, preferably from 0.5:1 to 5:1, more preferably from 0.7:1 to 2:1.

### Nonionic Surfactant

The composition herein may also comprise a nonionic surfactant. Non-limiting examples of nonionic surfactants suitable for use herein include: C₈-C₂₂ alkyl alkoxylated alcohols, such as Neodol® nonionic surfactants available from Shell; C₆-C₁₂ alkyl phenol alkoxylates wherein the alkoxylate units are a mixture of ethyleneoxy and propyleneoxy units; C₁₂-C₁₈ alcohol and C₆-C₁₂ alkyl phenol condensates with ethylene oxide/propylene oxide block alkyl polyamine ethoxylates such as Pluronic® available from BASF; C₁₄-C₂₂ mid-chain branched alkyl alkoxylates, BAEx, wherein x is from 1-30; alkylpolysaccharides, and specifically alkylpolyglycosides; polyhydroxy fatty acid amides; and ether capped poly(oxyalkylated) alcohol surfactants. Also useful herein as nonionic surfactants are alkoxylated ester surfactants such as those having the formula R¹C(O)O(R₂O)nR³ wherein R¹ is selected from linear and branched C₆-C₂₂ alkyl or alkylene moieties; R² is selected from C₂H₄ and C₃H₆ moieties and R³ is selected from H, CH₃, C₂H₅ and C₃H₇ moieties; and n has a value between 1 and 20. Such alkoxylated ester surfactants include the fatty methyl ester ethoxylates (MEE) and are well-known in the art.

In a preferred embodiment of the present invention, the anti-microbial laundry detergent composition comprises at least one C₈-C₂₂ alkyl alkoxylated alcohol-based nonionic surfactant, which has a weight average degree of alkoxylation ranging from about 1 to about 60. Preferably, such nonionic surfactants have a formula selected from the group consisting of:
(i) R₁—O—(C₂H₄O)ₗ—H, wherein R₁ is a C₈-C₂₂ alkyl group, and l represents the weight average degree of ethoxylation which ranges from about 1 to about 20; and
(ii) R₂—O—(C₂H₄O)ₘ-(AO)ₙ—H, wherein R₁ is a C₈-C₂₂ alkyl group, AO is an C₃-C₅ alkyleneoxy group, m and n represent the weight average degrees of ethoxylation or alkoxylation, respectively, with m ranging from about 18 to about 60, and n ranging from 0 to about 5.

The most preferred alkoxylated nonionic surfactant is C₁₂-C₁₅ alcohol ethoxylated with an average of 7 moles of ethylene oxide, e.g., Neodol®25-7 commercially available from Shell.

In a highly preferred embodiment, the anti-microbial laundry detergent composition of the present invention comprises:

a) from 0.02% to 0.3%, by weight of the composition, of the anti-microbial agent, wherein the anti-microbial agent is 4-4′-dichloro-2-hydroxy diphenyl ether;

b) from 10% to 40%, by weight of the composition, of the anionic surfactant system, wherein the anionic surfactant system comprises AES and LAS, preferably the weight ratio of the AES to LAS is from 0.1:1 to 10:1, preferably from 0.5:1 to 5:1, more preferably from 0.7:1 to 2:1; and

c) from 0.5% to 50%, by weight of the composition, of the alkoxylated nonionic surfactant, wherein the alkoxylated nonionic surfactant is C₁₂-C₁₆ alcohol ethoxylated with an average of 5 to 9 moles of ethylene oxides.

It has been surprisingly found that, by utilizing the specific anionic surfactant(s) and nonionic surfactant(s) at certain levels, the deposition of the anti-microbial agent onto treated fabrics is enhanced. Thus, an improved anti-microbial benefit towards treated fabrics is achieved.

Preferably in the anti-microbial laundry detergent composition of the present invention, the anionic surfactant system (i.e., the total level of the AES and LAS) is present in an amount ranging from about 5% to about 45%, more preferably from about 10% to about 40%, by weight of the composition. The nonionic surfactant is preferably present from about 0.5% to about 50%, more preferably from about 1% to about 40%, by weight of the composition. In one embodiment, the composition is anionic-rich with the weight ratio of the anionic surfactant system to the nonionic surfactant being at least about 2:1, alternatively from about 2:1 to about 35:1, alternatively from about 3:1 to about 30:1, alternatively from about 5:1 to about 28:1, alternatively from about 10:1 to about 25:1. In an alternative embodiment, the composition is nonionic-rich with the weight ratio of the nonionic surfactant to the anionic surfactant system being at least about 2:1, alternatively from about 2:1 to about 35:1, alternatively from about 3:1 to about 30:1, alternatively from about 5:1 to about 28:1, alternatively from about 10:1 to about 25:1.

The laundry detergent composition herein provides anti-microbial benefits against both Gram positive bacteria (e.g., Staphylococcus aureus) and Gram negative bacteria (e.g., Klebsiella pneumoniae). The composition preferably provides residual anti-microbial benefits to the fabrics treated by the composition, i.e., the diphenyl ether anti-microbial agent therein deposits onto the fabrics during a washing cycle and subsequently the deposited (i.e., residual) antimicrobial-agent prevents bacteria growth onto the fabrics during drying or storage or wear.

The laundry detergent composition herein may be acidic or alkali or pH neutral, depending on the ingredients incorporated in the composition. The pH range of the laundry detergent composition is preferably from 6 to 12, more preferably from 7 to 11, even more preferably from 8 to 10.

The laundry detergent composition can have any suitable viscosity depending on factors such as formulated ingredients and purpose of the composition. In one embodiment, the composition has a high shear viscosity value, at a shear rate of 20/sec and a temperature of 21° C., of 200 to 3,000 cP, alternatively 300 to 2,000 cP, alternatively 500 to 1,000 cP, and a low shear viscosity value, at a shear rate of 1/sec and a temperature of 21° C., of 500 to 100,000 cP, alternatively 1000 to 10,000 cP, alternatively 1,500 to 5,000 cP.

### Adjunct Ingredients

The laundry detergent composition herein may comprise adjunct ingredients. Suitable adjunct materials include but are not limited to: cationic surfactants, amphoteric surfactants, builders, chelating agents, rheology modifiers, dye transfer inhibiting agents, dispersants, enzymes, and enzyme stabilizers, catalytic materials, bleach activators, hydrogen peroxide, sources of hydrogen peroxide, preformed peracids, polymeric dispersing agents, clay soil removal/anti-redeposition agents, brighteners, suds suppressors, dyes, photobleaches, perfumes, perfume microcapsules, structure elasticizing agents, fabric softeners, carriers, hydrotropes, processing aids, solvents, hueing agents, structurants and/or pigments. The precise nature of these adjunct ingredients and the levels thereof in the laundry detergent composition will depend on the physical form of the composition and the nature of the cleaning operation for which it is to be used.

In one embodiment, the composition herein comprises a cationic surfactant. Non-limiting examples of cationic surfactants include: the quaternary ammonium surfactants, which can have up to 26 carbon atoms include: alkoxylate quaternary ammonium (AQA) surfactants; dimethyl hydroxyethyl quaternary ammonium; dimethyl hydroxyethyl lauryl ammonium chloride; polyamine cationic surfactants; cationic ester surfactants; and amino surfactants, specifically amido propyldimethyl amine (APA).

In one embodiment, the composition herein comprises an amphoteric surfactant. Non-limiting examples of amphoteric surfactants include: derivatives of secondary and tertiary amines, derivatives of heterocyclic secondary and tertiary amines, or derivatives of quaternary ammonium, quaternary phosphonium or tertiary sulfonium compounds. Preferred examples include: betaine, including alkyl dimethyl betaine and cocodimethyl amidopropyl betaine, C8 to C18 (or C12 to C18) amine oxides and sulfo and hydroxy betaines, such as N-alkyl-N,N-dimethylammino-1-propane sulfonate where the alkyl group can be C8 to C18, or C10 to C14.

Preferably, the amphoteric surfactant herein is selected from water-soluble amine oxide surfactants. A useful amine oxide surfactant has the formula:

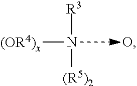

where R³ is a C₈₋₂₂ alkyl, a C₈₋₂₂ hydroxyalkyl, or a C₈₋₂₂ alkyl phenyl group; each R⁴ is a C₂₋₃ alkylene, or a C₂₋₃₂ hydroxyalkylene group; x is from 0 to about 3; and each R⁵ is a C₁₋₃ alkyl, a C₁₋₃ hydroxyalkyl, or a polyethylene oxide containing from about 1 to about 3 EOs. Preferably, the amine oxide surfactant may be a C₁₀₋₁₈ alkyl dimethyl amine oxide or a C₈₋₁₂ alkoxy ethyl dihydroxy ethyl amine oxide.

In one embodiment, the composition herein comprises a rheology modifier (also referred to as a “structurant” in certain situations), which functions to suspend and stabilize the microcapsules and to adjust the viscosity of the composition so as to be more applicable to the packaging assembly. The rheology modifier herein can be any known ingredient that is capable of suspending particles and/or adjusting rheology to a liquid composition. Preferably, the rheology modifier is selected from the group consisting of hydroxy-containing crystalline material, polyacrylate, polysaccharide, polycarboxylate, alkali metal salt, alkaline earth metal salt, ammonium salt, alkanolammonium salt, C₁₂-C₂₀ fatty alcohol, di-benzylidene polyol acetal derivative (DBPA), di-amido gallant, a cationic polymer comprising a first structural unit derived from methacrylamide and a second structural unit derived from diallyl dimethyl ammonium chloride, and a combination thereof. Preferably, the rheology modifier is a hydroxy-containing crystalline material generally characterized as crystalline, hydroxyl-containing fatty acids, fatty esters and fatty waxes, such as castor oil and castor oil derivatives. More preferably the rheology modifier is a hydrogenated castor oil (HCO).

### Method of Use

An important aspect of the present invention is directed to a method of using the above-described anti-microbial laundry detergent composition for laundering fabric to achieve, among others, an anti-microbial benefit. Specifically, the method comprises the step of forming the above-described anti-microbial laundry detergent composition first and then mixing a recommended dosage of it (e.g., from about 5 g to about 120 g) with a recommended volume (e.g., from about 1 liter to about 65 liters) of water or an aqueous solution in a container (the type of the container will depend on the type of washing process, e.g., hand washing or semi-automatic or fully automatic machine washing) to form a laundry washing liquor containing the diphenyl ether anti-microbial agent in the above-described TTW dosage, which is used to contact fabrics to be treated to achieve the desired anti-microbial benefit. Preferably, the anti-microbial benefit herein is determined by the JISL 1902 method described hereinafter.

In a typical hand washing process, from about 5 g to about 60 g of the anti-microbial laundry detergent composition is administered into a laundry washing basin comprising water to form a laundry washing solution. The washing solution in a laundry washing basin herein preferably has a volume from about 1 liter to about 20 liters, preferably from about 2 liters to about 15 liters, and most preferably from about 3 liters to about 10 liters.

Alternatively, in a typical machine washing process, from about 60 g to about 120 g of the anti-microbial laundry detergent composition is administered either directly into the drum of a washing machine, or into the detergent drawer of the washing machine. The washing machine then inject from about 20 liters to about 65 liters, preferably from about 25 liters to about 55 liters, of water into the drum and mixing it with the anti-microbial laundry detergent composition to form the laundry washing solution for machine washing the fabrics.

The temperatures of the laundry washing solution may range from −10° C. to 80° C., preferably from 5° C. to 60° C., and more preferably from 25° C. to 50° C.

Preferably, the method herein further comprises the step of contacting a fabric with the washing solution, wherein the fabric is in need of an anti-microbial treatment. For example, the presence of Gram positive bacteria and/or Gram negative bacteria is suspected on the fabric. The step of contacting the fabric with the laundry washing solution is preferably after the step of forming the laundry washing solution, but it can also occur simultaneously therewith.

### Composition Preparation

The laundry detergent composition of the present invention is generally prepared by conventional methods such as those known in the art of making laundry detergent compositions. Such methods typically involve mixing the essential and optional ingredients in any desired order to a relatively uniform state, with or without heating, cooling, application of vacuum, and the like, thereby providing laundry detergent compositions containing ingredients in the requisite concentrations.

### Water-Soluble Pouch

In one embodiment, the anti-microbial laundry detergent composition herein is contained within a water-soluble film thereby forming a water-soluble pouch. The pouch may be of such a size that it conveniently contains either a unit dose amount of the composition herein, suitable for the required operation, for example one wash, or only a partial dose, to allow a user greater flexibility to vary the amount used, e.g., depending on the size or degree of soiling of the wash load.

The water-soluble film of the pouch preferably comprises a polymer. The film can be obtained from methods known in the art, e.g., by casting, blow molding, extrusion molding, injection molding of the polymer. Non-limiting examples of the polymer for making the water-soluble film include: polyvinyl alcohols (PVAs), polyvinyl pyrrolidone, polyalkylene oxides, (modified) cellulose, (modified) cellulose-ethers or -esters or -amides, polycarboxylic acids and salts including polyacrylates, copolymers of maleic/acrylic acids, polyaminoacids or peptides, polyamides including polyacrylamide, polysaccharides including starch and gelatine, natural gums such as xanthum and carragum. Preferably, the water-soluble film comprises a polymer selected from the group consisting of polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, polyvinyl alcohols, hydroxypropyl methyl cellulose (HPMC), and a combination thereof. Most preferably, the water-soluble film comprises polyvinyl alcohol, e.g., M8639 available from MonoSol.

The pouch herein may comprise a single compartment or multiple compartments, preferably comprise multiple compartments, e.g., two compartments or three compartments. In the multi-compartment execution, one or more of the multiple compartments comprise the aforementioned anti-microbial laundry detergent composition. Preferably, the pouch comprises multiple films which form the multiple compartments, i.e., the inner volume of the multiple films is divided into the multiple compartments. The pouch of the present invention can be made by any suitable processes known in the art.

### Test Method

The anti-microbial efficacy for laundry detergent compositions is determined by the method as defined in the JISL 1902 method and described hereinafter.

1. Microorganism Preparation:

A. Aseptically add certain amount of nutrient broth into a lyophilized culture of Staphylococcus aureus or Klebsiella pneumoniae. Dissolve and suspend the culture in the nutrient broth to obtain a suspension. Streak a loop of the suspension onto a nutrient agar plate, and incubate at 37° C. for 24 hours to obtain a first generation subculture of bacterial suspension. Transfer a loop of the first generation subculture of bacterial suspension into 20 mL of nutrient broth with shaking, and incubate at 37° C. for 24 hours to obtain a second generation subculture of bacterial suspension. Transfer 0.4 mL of the second generation subculture of bacterial suspension into another 20 mL of nutrient broth with shaking, and incubate at 37° C. for 3 hours to obtain a third generation subculture of bacterial suspension.

B. Dilute the third generation subculture of bacterial suspension by 1/20 diluted nutrient broth to 1×10⁵ cells/mL to obtain a working culture.

C. Store the working culture at 4° C. The working culture cannot be stored overnight.

2. Fabric Washing:

A. Boil two fabric strips each having a width of 5 cm and length of 2.5 m (32 yarn/cm×32 yarn/cm, 100% plain weave cotton) in 3 L of a solution for 1 hour. The solution is prepared by 1.5 g of a nonionic soaked agent, 1.5 g of sodium carbonate, and 3000 mL of distilled water. The nonionic soaked agent is prepared by 5.0 g of alkylphenol ethoxylate, 5 g of sodium carbonate, and 1000 mL of distilled water. Rinse the fabric strips in boiled deionized water for 5 minutes. Place the fabric strips in cool deionized water for 5 minutes, and indoor dry. One fabric strip serves as a test fabric strip for following steps 2B-2I, and the other fabric strip is used as control (without experiencing steps 2B-2I).

B. Fix one end of the test fabric strip obtained from step 2A onto a stainless steel spindle at an outer position along the horizontal extension of the stainless steel spindle. The stainless steel spindle has 3 horizontal stands that are connected to one another. Wrap the test fabric strip around the 3 horizontal stands of the stainless steel spindle with sufficient tension to obtain a fabric wrapped spindle having 12 laps of fabric. Fix the other end of the test fabric strip onto the outer lap of the 12 laps of fabric via a pin. Sterilize the fabric wrapped spindle with pressure steam at 121° C. for 15 minutes.

C. Dissolve 5.903 g of calcium chloride dihydrate and 2.721 g of magnesium chloride hexahydrate in 100 mL of distilled water, and then sterilize the mixture with pressure steam at 121° C. for 20 minutes. Add 1 mL of the mixture into 1 L of distilled water to obtain a hard water solution.

D. Add sufficient amount of sample into 1 L of the hard water solution obtained from step 2C to obtain a solution having a concentration of 1055 ppm. Mix the solution by a magnetic stirrer for 4 minutes. Distribute 250 mL of the mixed solution into an exposure chamber to obtain a washing solution. Place the exposure chamber in a water bath and achieve the test temperature of (25±1°) C. The exposure chamber is then sterilized with pressure steam at 121° C. for 15 minutes.

E. Aseptically soak the fabric wrapped spindle obtained from step 2B into the washing solution in the exposure chamber, and close the exposure chamber with a lid.

F. Fix the exposure chamber onto a tumbler. Rotate the tumbler for 10 minutes. Then remove the fabric wrapped spindle from the exposure chamber. Place the fabric wrapped spindle in Haier iwash-1p Top Load Washing Machine and rinse for 2 minutes.

G. Discard the washing solution from the exposure chamber, and then add 250 mL of sterilized distilled water into the exposure chamber. Soak the rinsed fabric wrapped spindle in the newly added distilled water in the exposure chamber. Rotate the tumbler for 3 minutes.

H. Repeat step 2G.

I. Aseptically remove the fabric wrapped spindle out of the exposure chamber and remove the test fabric strip from the spindle. Air dry the test fabric strip overnight.

3. Fabric Incubation:

A. Cut the washed test fabric strip obtained from step 2I to square pieces having a side length of 2 cm. 3 sets of 0.4 g of the pieces serve as specimens for the following steps.

B. Put each set of specimens into a vial, and then sterilize the specimens with pressure steam at 121° C. for 15 minutes. After the sterilization, dry the specimens for 1 hour in a clean bench without a cap.

C. Inoculate 0.2 mL of the working culture obtained from step 1C onto each dried specimen. Incubate the vials containing the inoculated specimens at 37° C. for 18 hours.

D. Extract survivors on the incubated specimens, plate with nutrient agar, and incubate at 37° C. for 24-48 hours. Count the total colony-forming units (CFU) of each set of specimens, and obtain average results of the 3 sets. Take the log 10 value of CFU value as Mb.

E. In steps 3A-3D, use the fabric strip obtained from step 2A (that does not experience steps 2B-2I) as control. Take the log 10 value of CFU value as Ma.

4. Calculation of Bacteriostatic Activity Value:

Bacteriostatic Activity Value=Mb−Ma

A Bacteriostatic Activity Value of greater than 1.0, preferably greater than 1.5 and more preferably greater than 2.0, represents acceptable anti-microbial efficacy.

### EXAMPLE

The Examples herein are meant to exemplify the present invention but are not used to limit or otherwise define the scope of the present invention.

### Example 1

### Comparative Examples Showing the “Plateau” Effect of Diphenyl Ether Anti-Microbial Agent at Low TTW Dosages

Nine (9) liquid laundry detergent compositions are prepared, which include: (1) a control liquid laundry detergent composition 1A, with no diphenyl ether anti-microbial agent therein; and (2) eight liquid laundry detergent compositions 1B-1I containing the same ingredients as the control composition 1A, but in addition also containing Tinosan®HP100, which is a 4-4′-dichloro-2-hydroxy diphenyl ether commercially available from BASF, at different levels. Following is the compositional breakdown of 1A-1I:

TABLE 1

| Ingredients (Wt %) | 1A | 1B | 1C | 1D | 1E | 1F | 1G | 1H | 1I |
|---|---|---|---|---|---|---|---|---|---|
| C₁₂-₁₄AE₁₋₃S | 1.2 | 1.2 | 1.2 | 1.2 | 1.2 | 1.2 | 1.2 | 1.2 | 1.2 |
| C₁₁-₁₃LAS | 9 | 9 | 9 | 9 | 9 | 9 | 9 | 9 | 9 |
| Neodol ®25-7 a | 5.1 | 5.1 | 5.1 | 5.1 | 5.1 | 5.1 | 5.1 | 5.1 | 5.1 |
| Citric acid | 1.2 | 1.2 | 1.2 | 1.2 | 1.2 | 1.2 | 1.2 | 1.2 | 1.2 |
| Boric acid | 1.18 | 1.18 | 1.18 | 1.18 | 1.18 | 1.18 | 1.18 | 1.18 | 1.18 |
| C₁₂-C₁₈ fatty acid | 2.5 | 2.5 | 2.5 | 2.5 | 2.5 | 2.5 | 2.5 | 2.5 | 2.5 |
| Na-DTPA b | 0 | 0 | 0 | 0 | 0 | 0 | 0 | 0 | 0 |
| 1,2 propanediol | 0 | 0 | 0 | 0 | 0 | 0 | 0 | 0 | 0 |
| Calcium chloride | 0 | 0 | 0 | 0 | 0 | 0 | 0 | 0 | 0 |
| Silicone emulsion | 0.003 | 0.003 | 0.001 | 0.001 | 0.001 | 0.001 | 0.001 | 0.001 | 0.001 |
| Monoethanolamine | 0.6 | 0.6 | 0.6 | 0.6 | 0.6 | 0.6 | 0.6 | 0.6 | 0.6 |
| Sodium polyacrylate | 0 | 0 | 0 | 0 | 0 | 0 | 0 | 0 | 0 |
| NaOH | Up to | Up to | Up to | Up to | Up to | Up to | Up to | Up to | Up to |
| | pH 8 | pH 8 | pH 8 | pH 8 | pH 8 | pH 8 | pH 8 | pH 8 | pH 8 |
| Tinosan ®HP100 c | 0 | 0.024 | 0.031 | 0.039 | 0.047 | 0.071 | 0.095 | 0.118 | 0.142 |
| Brightener | 0.044 | 0.044 | 0.044 | 0.044 | 0.044 | 0.044 | 0.044 | 0.044 | 0.044 |
| Protease | 0.285 | 0.285 | 0.285 | 0.285 | 0.285 | 0.285 | 0.285 | 0.285 | 0.285 |
| Amylase | 0.14 | 0.14 | 0.14 | 0.14 | 0.14 | 0.14 | 0.14 | 0.14 | 0.14 |
| Dye | 0.001 | 0.001 | 0.001 | 0.001 | 0.001 | 0.001 | 0.001 | 0.001 | 0.001 |
| Perfume oil | 0.4 | 0.4 | 0.4 | 0.4 | 0.4 | 0.4 | 0.4 | 0.4 | 0.4 |
| Water | Q.S. | Q.S. | Q.S. | Q.S. | Q.S. | Q.S. | Q.S. | Q.S. | Q.S. |

a Neodol ®25-7 is C₁₂-C₁₅ alcohol ethoxylated with an average of 7 moles of ethylene oxide as a nonionic surfactant, available from Shell
b Penta sodium salt diethylene triamine penta acetic acid as a chelant
c Tinosan ®HP100 is 4-4′-dichloro-2-hydroxy diphenyl ether, available from BASF

Comparative experiments of measuring the anti-microbial efficacy of the test compositions 1A-1I are conducted according to the JISL 1902 method as described hereinabove. Dilution of the test compositions results in laundry washing solutions with a detergent TTW dosage of about 1055 ppm. Laundry washing solution formed by the test composition 1A has 0 ppm of Tinosan®HP100 in TTW dosage. Laundry washing solutions formed by test compositions 1B-1I have corresponding Tinosan®HP100 TTW dosages of 0.25 ppm, 0.33 ppm, 0.41 ppm, 0.5 ppm, 0.75 ppm, 1.0 ppm, 1.25 ppm, and 1.5 ppm. Each test composition is added in step 2D of the JISL 1902 method as sample. Following Table 2 shows Bacteriostatic Activity Values against Staphylococcus aureus (a Gram positive bacterium) and Klebsiella pneumoniae (a Gram negative bacterium).

TABLE 2

| | | Bacteriostatic Activity | |
|---|---|---|---|
| | | Value under JIS L1902 | |
| Test | Tinosan TTW | Against | |
| Composition | Dosage | S. aureus | Against K. pneumoniae |
| 1A | 0 ppm | 0.7 | 0.2 |
| 1B | 0.25 ppm | 3.6 | 1.7 |
| 1C | 0.33 ppm | 3.4 | 2.2 |
| 1D | 0.41 ppm | 4.0 | 2.1 |
| 1E | 0.5 ppm | 3.8 | 2.1 |
| 1F | 0.75 ppm | 4.1 | 2.3 |
| 1G | 1.0 ppm | 4.0 | 2.3 |
| 1H | 1.25 ppm | 3.9 | 2.3 |
| 1I | 1.5 ppm | 4.0 | 2.7 |

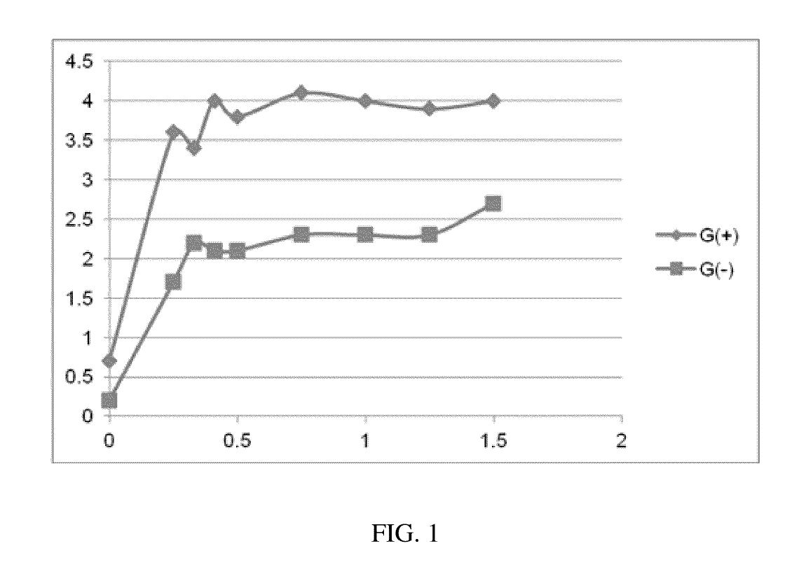

FIG. 1 is a graph that plots the above-listed Bacteriostatic Activity Values against gram-positive and gram-negative as functions of the TTW dosages of Tinosan®HP100. It can be observed that the bacteriostatic activity of Tinosan®HP100 reaches a plateau effect within a critical TTW dosage range of from about 0.25 ppm to about 1 ppm, preferably from about 0.3 ppm to about 0.7 ppm, more preferably from about 0.4 ppm to about 0.6 ppm, and most preferably from about 0.45 ppm to about 0.55 ppm. Dosing of Tinosan®HP100 above this range does not significantly improve the Bacteriostatic Activity Values. Therefore, it can be concluded that by adjusting the TTW dosage of Tinosan®HP100 to within this critical range, one can surprisingly and unexpectedly achieve the same or comparable anti-microbial effect as that achieved by higher TTW dosages.

### Examples 2A-2E

### Exemplary Formulations of Anionic-Rich Liquid Laundry Detergent Compositions

The following liquid laundry detergent compositions shown in Table 3 are made comprising the listed ingredients in the listed proportions (weight %). These detergent compositions represent standard detergent products that can be used to form laundry washing solutions with a total detergent TTW dosage of about 1000 ppm.

TABLE 3

| | 2A | 2B | 2C |
|---|---|---|---|
| C₁₂-₁₄AE₁₋₃S | 13 | 8.3 | 10 |
| C₁₁-₁₃LAS | 3 | 5.5 | 6.5 |
| Neodol ®25-7 a | 1.4 | 1.2 | 1.4 |
| Citric acid | 0 | 2 | 1.7 |
| Boric acid | 0 | 2 | 1.9 |
| C₁₂-C₁₈ fatty acid | 1.5 | 1.2 | 1.3 |
| Na-DTPA b | 0.06 | 0.2 | 0.4 |
| 1,2 propanediol | 0 | 1.2 | 2.5 |
| Calcium chloride | 0 | 0 | 0.06 |
| Silicone emulsion | 0 | 0.0025 | 0.0025 |
| Monoethanolamine | 0.07 | 0 | 0 |
| Sodium polyacrylate | 1.4 | 0 | 0 |
| NaOH | Up to pH 8 | Up to pH 8 | Up to pH 8 |
| Tinosan ®HP100 c | 0.04 | 0.04 | 0.04 |
| Brightener | 0 | 0.06 | 0.06 |
| Protease | 0 | 0 | 0.45 |
| Amylase | 0 | 0 | 0.08 |
| Dye | 0 | 0.002 | 0.002 |
| Perfume oil | 0 | 0.6 | 0.6 |
| Water | Add to 100 | Add to 100 | Add to 100 |

| | 2D | 2E |
|---|---|---|
| C₁₁-C₁₃ LAS | 3.0 | 11.3 |
| C₁₂-C₁₄AE₃S | 1.4 | 24.6 |
| Neodol ®25-7 a | 0.5 | 2.4 |
| Citric acid | 0.5 | 0.7 |
| C₁₂-C₁₈ fatty acid | 0.5 | 2.4 |
| Sodium cumene sulphonate | 1.3 | 1.3 |
| 1,2 propanediol | 9.5 | 9.5 |
| Monoethanolamine | 1.2 | 3.2 |
| Tinosan ®HP100 c | 0.09 | 0.09 |
| Water | Add to 100 | Add to 100 |

a Neodol ®25-7 is C₁₂-C₁₅ alcohol ethoxylated with an average of 7 moles of ethylene oxide as a nonionic surfactant, available from Shell
b Penta sodium salt diethylene triamine penta acetic acid as a chelant
c Tinosan ®HP100 is 4-4′-dichloro-2-hydroxy diphenyl ether, available from BASF

### Examples 3A-3C

### Exemplary Formulations of Nonionic-Rich Liquid Laundry Detergent Compositions

The following liquid laundry detergent compositions shown in Table 4 are made comprising the listed ingredients in the listed proportions (weight %). These detergent compositions represent concentrated detergent products that are typically used to form laundry washing solutions with a total detergent TTW dosage of about 350 ppm.

TABLE 4

| | 3A | 3B | 3C |
|---|---|---|---|
| C₁₂-₁₄AE₁₋₃S | 21 | 0 | 7 |
| C₁₁-₁₃LAS | 0 | 8 | 3 |
| Neodol ®25-7 a | 37 | 45 | 44 |
| Citric acid | 0 | 2 | 1.7 |
| Boric acid | 0 | 0 | 1.9 |
| C₁₂-C₁₈fatty acid | 4 | 1 | 1.3 |
| Na-DTPA b | 0 | 0.2 | 0.4 |
| 1,2 propanediol | 16 | 6 | 2.5 |
| Calcium chloride | 0 | 0 | 0.06 |
| Silicone emulsion | 0 | 0.0025 | 0.0025 |
| Monoethanolamine | 4 | 1 | 1 |
| Sodium polyacrylate | 0 | 0.5 | 0 |
| NaOH | Up to pH 8 | Up to pH 8 | Up to pH 8 |
| Tinosan ®HP100 c | 0.14 | 0.12 | 0.16 |
| Brightener | 0 | 0.06 | 0.06 |
| Protease | 0 | 0 | 0.45 |
| Amylase | 0 | 0 | 0.08 |
| Dye | 0 | 0.002 | 0.002 |
| Perfume oil | 0 | 0.6 | 0.6 |
| Water | Add to 100 | Add to 100 | Add to 100 |

a Neodol ®25-7 is C₁₂-C₁₅ alcohol ethoxylated with an average of 7 moles of ethylene oxide as a nonionic surfactant, available from Shell
b Penta sodium salt diethylene triamine penta acetic acid as a chelant
c Tinosan ®HP100 is 4-4′-dichloro-2-hydroxy diphenyl ether, available from BASF

The liquid laundry detergent compositions of Examples 2A-2E and 3A-3C are prepared by the following steps:

a) mixing a combination of NaOH (if any) and water in a batch container by applying a shear of 200 rpm;

b) adding citric acid (if any), boric acid (if any), and C₁₁-C₁₃ LAS into the batch container, keeping on mixing by applying a shear of 200 rpm;
c) cooling down the temperature of the combination obtained in step b) to 25° C.;

d) adding C₁₂₋₁₄AE₁₋₃S, Na-DTPA (if any), Neodol®25-7, C₁₂-C₁₈ fatty acid, 1,2 propanediol (if any), monoethanolamine (if any), calcium chloride (if any), sodium cumene sulphonate (if any), silicone emulsion (if any), sodium polyacrylate (if any), and Tinosan®HP100 into the batch container, mixing by applying a shear of 250 rpm until the combination is homogeneously mixed, and adjusting pH to 8;

e) adding brightener (if any), protease (if any), amylase (if any), dye (if any), and perfume oil (if any) into the batch container, mixing by applying a shear of 250 rpm, thus forming a liquid laundry detergent composition,
wherein each ingredient in the composition is present in the level as specified for Examples 2A-2E and 3A-3C.

Unless otherwise indicated, all percentages, ratios, and proportions are calculated based on weight of the total composition. All temperatures are in degrees Celsius (° C.) unless otherwise indicated. All measurements made are at 25° C., unless otherwise designated. All component or composition levels are in reference to the active level of that component or composition, and are exclusive of impurities, for example, residual solvents or by-products, which may be present in commercially available sources.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of laundering fabric, comprising the steps of:
a) diluting an anti-microbial laundry detergent composition that comprises a diphenyl ether anti-microbial agent with water or an aqueous solution by an order ranging from 900 to 3000 times by weight to form a laundry washing liquor having a Through-The-Wash (TTW) dosage of said diphenyl ether anti-microbial agent ranging from 0.25 to 1 ppm; and
b) contacting fabrics in need of laundering with said laundry washing liquor.

2. The method of claim 1, wherein the TTW dosage of said diphenyl ether anti-microbial agent in the laundry washing liquor ranges from 0.3 to 0.7 ppm, preferably from 0.4 to 0.6 ppm, and more preferably from 0.45 to 0.55 ppm.

3. The method of claim 1, wherein said anti-microbial laundry detergent composition further comprises one or more anionic and/or nonionic surfactants selected from the group consisting of: (1) C₁₀-C₂₀ linear alkyl benzene sulphonates; (2) C₁₀-C₂₀ linear or branched alkylalkoxy sulfates having a weight average degree of alkoxylation ranging from 0.1 to 5.0; (3) C₁₀-C₂₀ linear or branched alkyl sulfates; (4) C₁₀-C₂₀ linear or branched alkyl ester sulfates; (5) C₁₀-C₂₀ linear or branched alkyl ester sulfonates; (6) C₁₀-C₂₀ linear or branched alkyl ester alkoxylates; (7) C₈-C₂₂ alkyl alkoxylated alcohols having a weight average degree of alkoxylation from 1 to 60; and combinations thereof.

4. The method according to claim 1, wherein said anti-microbial laundry detergent composition comprises at least one anionic surfactant selected from the group consisting of C₁₀-C₂₀ linear alkyl benzene sulphonates, C₁₀-C₂₀ linear or branched alkylalkoxy sulfates having an average degree of alkoxylation ranging from 0.1 to 5.0, and combinations thereof.

5. The method according to claim 1, wherein said anti-microbial laundry detergent composition comprises at least one nonionic surfactant having a formula selected from the group consisting of:
(i) R₁—O—(C₂H₄O)ₗ—H, wherein R₁ is a C₈-C₂₂ alkyl group, and l represents the weight average degree of ethoxylation which ranges from 1 to 20; and
(ii) R₂—O—(C₂H₄O)ₘ-(AO)ₙ—H, wherein R₁ is a C₈-C₂₂ alkyl group, AO is an C₃-C₅ alkyleneoxy group, m and n represent the weight average degrees of ethoxylation or alkoxylation, respectively, with m ranging from 18 to 60, and n ranging from 0 to 5.

6. The method according to claim 1, wherein said diphenyl ether anti-microbial agent is a hydroxyl diphenyl ether of formula (I): 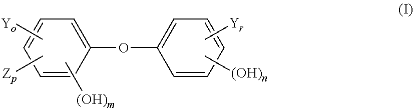
wherein:
each Y is independently selected from chlorine, bromine, or fluorine,
each Z is independently selected from SO₂H, NO₂, or C₁-C₄ alkyl,
r is 0, 1, 2, or 3,
o is 0, 1, 2, or 3,
p is 0, 1, or 2,
m is 1 or 2, and
n is 0 or 1.

7. The method according to claim 1, wherein said diphenyl ether anti-microbial agent is selected from the group consisting of 4-4′-dichloro-2-hydroxy diphenyl ether, 2,4,4′-trichloro-2′-hydroxy diphenyl ether, and a combination thereof, and wherein said diphenyl ether anti-microbial agent is preferably 4-4′-dichloro-2-hydroxy diphenyl ether.

8. The method according to claim 1, wherein said anti-microbial laundry detergent composition comprises said diphenyl ether anti-microbial agent in an amount from 0.02% to 0.3% by total weight of the composition.

9. An anti-microbial laundry detergent composition, comprising a diphenyl ether anti-microbial agent in an amount sufficient for delivering a Through-The-Wash (TTW) dosage of the diphenyl ether anti-microbial agent ranging from 0.25 to 1 ppm in a laundry washing liquor formed by said anti-microbial laundry detergent composition.

10. The anti-microbial laundry detergent composition of claim 9, comprising from 0.02% to 0.3% of said diphenyl ether anti-microbial agent by total weight of the composition, and wherein said anti-microbial laundry detergent composition is constructed and designed to form the laundry washing liquor through dilution of said composition in water or an aqueous solution by an order ranging from 900 to 3000 times by weight.

11. A laundry washing liquor comprising an aqueous solution of a diphenyl ether anti-microbial agent with a Through-The-Wash (TTW) dosage ranging from 0.25 to 1 ppm.

12. The laundry washing liquor of claim 11, wherein the TTW dosage of said diphenyl ether anti-microbial agent ranges from 0.3 to 0.7 ppm, preferably from 0.4 to 0.6 ppm, and more preferably from 0.45 to 0.55 ppm.

13. The laundry washing liquor of claim 11, comprising one or more anionic and/or nonionic surfactants selected from the group consisting of: (1) C₁₀-C₂₀ linear alkyl benzene sulphonates; (2) C₁₀-C₂₀ linear or branched alkylalkoxy sulfates having a weight average degree of alkoxylation ranging from 0.1 to 5.0; (3) C₁₀-C₂₀ linear or branched alkyl sulfates; (4) C₁₀-C₂₀ linear or branched alkyl ester sulfates; (5) C₁₀-C₂₀ linear or branched alkyl ester sulfonates; (6) C₁₀-C₂₀ linear or branched alkyl ester alkoxylates; (7) C₈-C₂₂ alkyl alkoxylated alcohols having a weight average degree of alkoxylation from 1 to 60; and combinations thereof.

14. The laundry washing liquor according to claim 11, comprising at least one anionic surfactant selected from the group consisting of C₁₀-C₂₀ linear alkyl benzene sulphonates, C₁₀-C₂₀ linear or branched alkylalkoxy sulfates having an average degree of alkoxylation ranging from 0.1 to 5.0, and combinations thereof.

15. The laundry washing liquor according to claim 11, comprising at least one nonionic surfactant having a formula selected from the group consisting of:
(i) R₁—O—(C₂H₄O)ₗ—H, wherein R₁ is a C₈-C₂₂ alkyl group, and l represents the weight average degree of ethoxylation which ranges from 1 to 20; and
(ii) R₂—O—(C₂H₄O)ₘ-(AO)ₙ—H, wherein R₁ is a C₈-C₂₂ alkyl group, AO is an C₃-C₅ alkyleneoxy group, m and n represent the weight average degrees of ethoxylation or alkoxylation, respectively, with m ranging from 18 to 60, and n ranging from 0 to 5.

16. The laundry washing liquor according to claim 11, wherein said diphenyl ether anti-microbial agent is a hydroxyl diphenyl ether of formula (I): 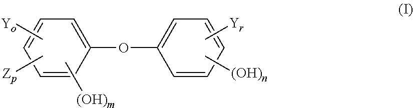
wherein:
each Y is independently selected from chlorine, bromine, or fluorine,
each Z is independently selected from SO₂H, NO₂, or C₁-C₄ alkyl,
r is 0, 1, 2, or 3,
o is 0, 1, 2, or 3,
p is 0, 1, or 2,
m is 1 or 2, and
n is 0 or 1.

17. The laundry washing liquor according to claim 11, wherein said diphenyl ether anti-microbial agent is selected from the group consisting of 4-4′-dichloro-2-hydroxy diphenyl ether, 2,4,4′-trichloro-2′-hydroxy diphenyl ether, and a combination thereof, and wherein said diphenyl ether anti-microbial agent is preferably 4-4′-dichloro-2-hydroxy diphenyl ether.
